(19) United States
(12) Patent Application Publication
(10) Pub. No.: US 2025/0150914 A1
(43) Pub. Date: May 8, 2025

(54) ELECTRONIC APPARATUS, CONTROL METHOD OF THE SAME, AND STORAGE MEDIUM

(71) Applicant: CANON KABUSHIKI KAISHA, Tokyo (JP)

(72) Inventor: TOMOYUKI KAWANA, Kanagawa (JP)

(21) Appl. No.: 18/929,186

(22) Filed: Oct. 28, 2024

(30) Foreign Application Priority Data
Nov. 6, 2023 (JP) 2023-189526

(51) Int. Cl. H04W 36/08; H04W 36/00

(52) U.S. Cl. CPC H04W 36/08; H04W 36/008357

(57) ABSTRACT

An electronic apparatus including: a receiving unit configured to receive a change request of an access point serving as a connection destination from a connected access point; a setting unit configured to set a setting value relating to security of the electronic apparatus; and a control unit configured to control whether or not to suppress change of an access point serving as the connection destination based on the change request, based on the setting value set by the setting unit.

### BACKGROUND OF THE INVENTION

### Field of the Invention

The present invention relates to an electronic apparatus that can be connected via a wireless LAN, a method for controlling the electronic apparatus, and a computer-readable storage medium storing a program.

### Description of the Related Art

In a wireless LAN environment to which an electronic apparatus is connected, there is a technology for dynamically switching a connection destination access point (AP) in order to efficiently exchange data between an AP and a station (STA) in an extended service set (ESS) including a plurality of APs. When it is determined that the connection destination AP should be switched based on a congestion state of the AP to which the STA is connected, a vacancy state of other APs, radio wave conditions, or the like, the AP to which the STA is connected transmits a connection destination AP change request to the STA. Upon receiving the AP change request, the STA switches the connection destination AP in accordance with the request, and thus can be connected to an appropriate AP.

Japanese Patent Laid-Open No. 2021-175068 discloses the following as processing for requesting change of a connection destination from a router having functions of an AP to a wireless slave device that is connected to the router. A mobile router (MR1) that can be connected to a plurality of wireless slave devices confirms whether or not a wireless slave terminal supports IEEE 802.11v. Whether or not the wireless slave terminal supports IEEE 802.11v can be determined based on an association request frame transmitted from the wireless slave terminal to the MR1 when the terminal establishes a wireless connection with the MR1. If the wireless slave terminal supports IEEE 802.11v, a BSS transition management (BTM) request frame is transmitted to the wireless slave terminal. BSSID of a master device router RT2 is specified as a connection destination in a BSS transition candidate list entries field of the BTM request frame. Thus, switching of the connection destination of the slave terminal is prompted, and the wireless slave terminal switches the connection destination from the MR1 to the RT2 in accordance with the received BTM request frame.

### SUMMARY OF THE INVENTION

The present invention provides an electronic apparatus that can control dynamic switching of a connection destination AP to avoid security risks of the electronic apparatus, a method for controlling the electronic apparatus, and a computer-readable storage medium storing a program.

The present invention in one aspect provides an electronic apparatus comprising at least one memory and at least one processor which function as: a receiving unit configured to receive a change request of an access point serving as a connection destination from a connected access point; a setting unit configured to set a setting value relating to security of the electronic apparatus; and a control unit configured to control whether or not to suppress change of an access point serving as the connection destination based on the change request, based on the setting value set by the setting unit.

According to the present invention, it is possible to control dynamic switching of a connection destination AP to avoid security risks of an electronic apparatus.

Further features of the present invention will become apparent from the following description of exemplary embodiments with reference to the attached drawings.

### BRIEF DESCRIPTION OF THE DRAWINGS

FIG. 1 is a diagram showing a system configuration.

FIGS. 2A and 2B are diagrams showing a configuration of a multifunction peripheral (MFP).

FIGS. 3A, 3B, and 3C are diagrams showing an operation display unit of the MFP.

FIGS. 4A and 4B are diagrams showing a configuration of a portable terminal device.

FIG. 5 is a diagram showing a configuration of an access point (AP).

FIG. 6 is a sequence diagram showing processing performed based on a connection destination change request from an AP.

FIGS. 7A, 7B, 7C, 7D, 7E, 7F, and 7G are diagrams showing screen examples of the operation display unit of the MFP.

FIG. 8 is a diagram showing setting values of security setting items for each security type.

FIG. 9 is a flowchart showing an example of processing performed by the MFP in response to a connection destination change request.

FIGS. 10A and 10B are conceptual diagrams showing a method for determining whether or not a connection destination AP can be changed.

FIG. 11 is a flowchart showing another example of processing performed by the MFP in response to a connection destination change request.

FIG. 12 is a flowchart showing processing performed at the time of reboot after a security type is set.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Depending on the state of a STA, there are cases where no problem occurs even when an AP is switched and cases where a problem occurs when the AP is switched. In those cases where a problem occurs when the AP is switched, it is not desirable to switch the connection destination AP in response to an AP change request received from the AP.

For example, a case is conceivable in which there is a security risk in an AP to which the connection destination is to be switched. If the connection destination is switched to a malicious AP that pretends to be a safe AP, the contents of communication with the STA may be leaked. In another case, if the STA is connected to an AP that is operating using old firmware without updating the firmware, the STA may be exposed to an attack exploiting vulnerability of the firmware. Therefore, when it is determined by an electronic apparatus that there is a security risk when the AP is switched, it is desirable not to switch the AP in accordance with an AP switching request.

According to the present invention, it is possible to control dynamic switching of a connection destination AP to avoid security risks of an electronic apparatus.

### System Configuration

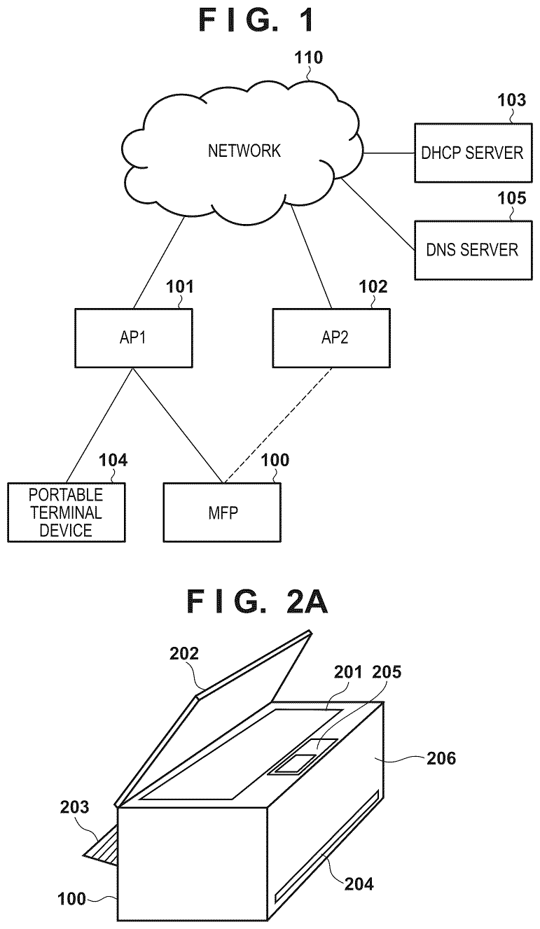

FIG. 1 shows a configuration example of a system according to the present embodiment. This system is a wireless communication system in which a plurality of communication devices can perform wireless communication with each other, for example. In the example shown in FIG. 1, the system includes, as communication devices, a portable terminal device 104, a multifunction peripheral (MFP) 100, AP 101 and AP 102, which are access points, a DHCP server 103, and a network 110. Note that the AP 101 and AP 102 may be shown as AP1 and AP2 in the drawings. The portable terminal device 104 is a device that has a wireless communication function using a wireless LAN or the like. In the following description, a wireless LAN may be referred to as “WLAN”. The portable terminal device 104 may be a personal information terminal such as a personal digital assistant (PDA), a mobile phone (smartphone), a digital camera, a personal computer, or the like.

The MFP 100 has a print function and may further have a reading (scanner) function, a FAX function, and a telephone function. Also, the MFP 100 of the present embodiment has a communication function that enables wireless communication with the portable terminal device 104. In the present embodiment, a case where the MFP 100 is used is described as an example, but there is no limitation to this example. For example, instead of the MFP 100, it is also possible to use a printer, a scanner, a projector, a portable terminal, a smartphone, a notebook computer, a tablet terminal, a PDA, a digital camera, a music reproduction device, a television, a smart speaker, or the like having the communication function. Note that MFP is an acronym of Multi Function Peripheral.

The AP 101 is provided separately from (outside) the portable terminal device 104 and the MFP 100 and operates as a base station device of the WLAN. A communication device having a WLAN communication function can perform communication via the AP 101 in an infrastructure mode of the WLAN. In the following description, an access point may be referred to as an “AP”. Also, the infrastructure mode may be referred to as a “wireless infrastructure mode”. The AP 101 performs wireless communication with a (authenticated) communication device for which connection to the AP 101 has been permitted, and relays wireless communication between the communication device and another communication device. Also, the AP 101 is connected to a wired communication network, for example, and may relay communication between a communication device connected to the wired communication network and another communication device that has established a wireless connection with the AP 101.

The AP 102 has functions equivalent to those of the AP 101, and the MFP 100 switches the connection destination from the AP 101 to the AP 102 as necessary. The DHCP server 103 is connected to the MFP 100 via the AP 101 and the network 110 and provides a service to the MFP 100 in response to a request from the MFP 100. Note that, in FIG. 1, the DHCP server 103 is connected as an apparatus different from the AP 101 and the AP 102, but a configuration is also possible in which the AP 101 and the AP 102 have a DHCP server function. A DNS server 105 is connected to the MFP 100 and the portable terminal device 104 via the AP 101 and the network 110 and provides a service for name resolution in response to a request from the MFP 100 or the portable terminal device 104. Here, the network 110 may be the Internet, a closed network of a company, or a mobile phone network.

### External Configuration of MFP

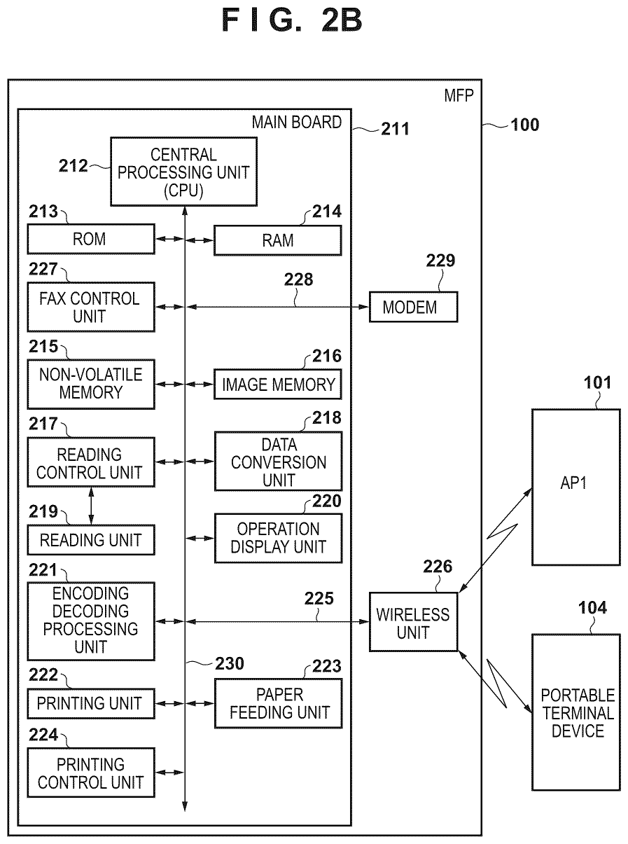

FIG. 2A shows an example of an external configuration of the MFP 100. The MFP 100 includes a document table 201, a document cover 202, a printing paper inlet 203, a printing paper outlet 204, and an operation display unit 205, for example. The document table 201 is a table on which a document that is to be scanned is placed. The document cover 202 is a cover for pressing the document placed on the document table 201 and preventing light emitted from a light source toward the document for scanning from leaking to the outside. The printing paper inlet 203 is an inlet to which sheets of paper having various sizes can be set. The printing paper outlet 204 is an outlet from which printed sheets are discharged. Sheets of paper set on the printing paper inlet 203 are conveyed to a printing unit one by one, subjected to printing in the printing unit, and then discharged from the printing paper outlet 204. The operation display unit 205 includes keys such as letter input keys, cursor keys, an enter key, and a cancel key, LEDs, an LCD, etc., and is configured to be capable of accepting operations made by a user to boot various functions of the MFP and set various settings. The operation display unit 205 may also include a touch panel display. The MFP 100 has a wireless communication function for communicating via the WLAN and includes a wireless communication antenna 206 to be used for the wireless communication, although the antenna does not necessarily have to be visible from the outside. Similarly to the portable terminal device 104, the MFP 100 can perform wireless communication via the WLAN in the 2.4 GHz and 5 GHz bands.

### Configuration of MFP

FIG. 2B shows an example configuration of the MFP 100. The MFP 100 includes a main unit 211 that performs main control of the MFP 100 and a wireless unit 226 that is a communication module that performs WLAN communication with use of at least one common antenna. Also, the MFP 100 includes a modem 229 for wired communication, for example. The main unit 211 is simply a unit including functional blocks other than the wireless unit 266 and the modem 229. The main unit 211 includes a central processing unit (CPU) 212, a ROM 213, a RAM 214, a non-volatile memory 215, an image memory 216, a reading control unit 217, a data conversion unit 218, a reading unit 219, and an encoding decoding processing unit 221, for example. The main unit 211 also includes a printing unit 222, a paper feeding unit 223, a printing control unit 224, an operation display unit 220, and a FAX control unit 227, for example. These functional units included in the main unit 211 are connected to each other via a system bus 230 controlled by the CPU 212. Also, the main unit 211 and the wireless unit 226 are connected via a dedicated bus 225, and the main unit 211 and the modem 229 are connected via a bus 228, for example.

The CPU 212 is a system control unit including at least one processor and controls the entire MFP 100. Processing performed by the MFP 100 described below is realized by the CPU 212 by executing a program stored in the ROM 213, for example. Note that dedicated hardware may also be prepared for each process. Control programs executed by the CPU 212, an embedded OS program, and the like are stored in the ROM 213. In the present embodiment, the CPU 212 performs software control such as scheduling and task switching by executing each control program stored in the ROM 213 under management of an embedded OS, which is also stored in the ROM 213.

The RAM 214 is constituted by a SRAM, for example. Data such as program control variables, setting values registered by the user, and data such as management data of the MFP 100 are stored in the RAM 214. The RAM 214 may also be used as a buffer for various works. The non-volatile memory 215 is constituted by a memory such as a flash memory, for example, and keeps data stored therein even when the power source of the MFP 100 is turned off. The image memory 216 is constituted by a memory such as a DRAM. Image data received via the wireless unit 226, image data processed by the encoding decoding processing unit 221, and the like are accumulated in the image memory 216. Note that the memory configuration of the MFP 100 is not limited to the above configuration. The data conversion unit 218 performs analysis of data in various forms and conversion from image data to print data, for example.

The reading control unit 217 controls the reading unit 219 (e.g., a contact image sensor (CIS)) to optically read a document placed on the document table 201. The reading control unit 217 converts an image obtained by optically reading the document to electrical image data (image signal) and outputs the image data. At this time, the reading control unit 217 may output the image data after performing various types of image processing such as binarization processing or halftone processing.

The operation display unit 220 is the operation display unit 205 described with reference to FIG. 2A and executes display on a display under display control performed by the CPU 212 and generates signals in response to a user operation, for example.

The encoding decoding processing unit 221 performs encoding processing, decoding processing, and scaling processing on image data (JPEG, PNG, etc.) handled by the MFP 100.

The paper feeding unit 223 holds sheets of paper to be used for printing. The paper feeding unit 223 can supply the sheets of paper that have been set, under control performed by the printing control unit 224. The paper feeding unit 223 may include a plurality of paper feeding units to hold a plurality of types of sheets in the single apparatus, and from which of the paper feeding units sheets are supplied can be controlled by the printing control unit 224.

The printing control unit 224 performs various types of image processing such as smoothing processing, printing density correction processing, and color correction on image data to be printed, and outputs processed image data to the printing unit 222. The printing unit 222 is configured to be capable of executing ink jet printing processing, for example, and causes a print head to emit ink supplied from an ink tank to record an image on a print media such as paper. Note that the printing unit 222 may also be configured to be capable of executing other printing processing such as electrophotographic printing processing. Also, the printing control unit 224 may periodically read information regarding the printing unit 222 and update status information including an ink level in the ink tank, a state of the print head, and the like stored in the RAM 214, for example.

The wireless unit 226 can provide the WLAN communication function, such as a function similar to a function realized by combining a WLAN unit 401 of the portable terminal device 104, for example. That is to say, the wireless unit 226 converts data to a packet in accordance with standards of the WLAN and transmits the packet to another device, and also restores original data from a packet received from an external device and outputs the data to the CPU 212. The wireless unit 226 can perform communication as a station in accordance with the IEEE 802.11 standard series. In particular, the wireless unit 226 can perform communication as a station in accordance with IEEE 802.11a/b/g/n/ac/ax. In the following description, a station may be referred to as a “STA”. Also, the wireless unit 226 can perform communication as a STA that supports Wi-Fi Agile Multiband (trademark).

The wireless unit 226 supports IEEE 802.11ax, i.e., Wi-Fi 6 (trademark) and can perform processing in accordance with IEEE 802.11ax. That is to say, the MFP 100 can perform operations (processing) as either or both of a STA that supports (conforms to) OFDMA and a STA that supports (conforms to) TWT. OFDMA is an abbreviation of Orthogonal Frequency-Division Multiple Access. TWT is an abbreviation of Target Wake Time. The MFP 100 supports TWT, and accordingly, timings of data communication from a master device to the STA are adjusted. The wireless unit 226 (MFP 100), which is the STA, causes the communication function to transition to a sleep state when it is not necessary to wait for a signal to be received. This saves power consumption. The wireless unit 226 also supports Wi-Fi 6E (trademark). That is to say, the wireless unit 226 can perform communication in the 6 GHz band (5.925 GHz to 7.125 GHZ). The 6 GHz band does not include a range in which dynamic frequency selection (DFS) is performed, as in the 5 GHz band. Accordingly, communication disconnection due to standby time for DFS does not occur in communication performed in the 6 GHz band, and more comfortable communication can be expected.

Note that the portable terminal device 104 and the MFP 100 can perform P2P (WLAN) communication based on WFD, and the wireless unit 226 has a software access point (soft AP) function or a group owner function. That is to say, the wireless unit 226 can establish a P2P communication network and determine a channel to be used for the P2P communication.

### Operation Display Unit of MFP

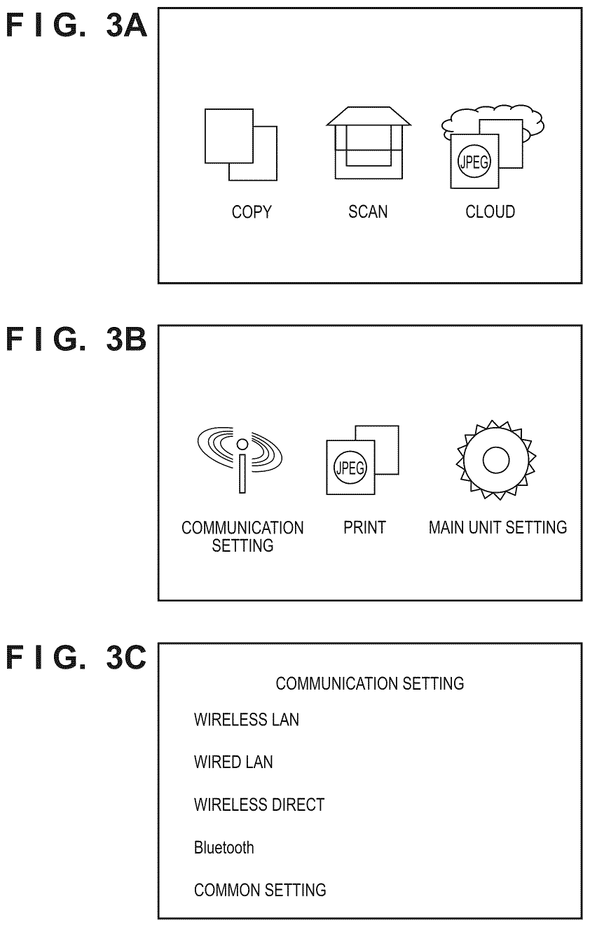

FIGS. 3A to 3C schematically show an example of screens displayed on a display (touch panel display) included in the operation display unit 220 of the MFP 100. FIG. 3A shows an example of a home screen displayed in a state (idling state or standby state) in which the power source of the MFP 100 has been turned on and operations such as printing and scanning are not performed. Display items (menu items) respectively corresponding to copy, scan, and cloud are displayed in FIG. 3A. The cloud is a menu item relating to a cloud function provided with use of Internet communication. When any of the menu items is selected through an operation made on a key or the touch panel, the MFP 100 can start to execute a corresponding setting or function. Upon accepting an operation made on a key or the touch panel via the home screen shown in FIG. 3A, the MFP 100 can seamlessly display a screen other than the screen shown in FIG. 3A.

FIG. 3B shows a display example of another portion of the home screen, and the home screen transitions from the state shown in FIG. 3A to the state shown in FIG. 3B in response to an operation (e.g., a slide operation to the left or the right) for displaying another page of the home screen. Display items (menu items) respectively corresponding to communication setting, print, and main unit setting are displayed in FIG. 3B. When any of these menu items is selected, a function corresponding to the selected menu item, i.e., a print function, main unit setting, or communication setting is executed.

FIG. 3C shows a display example of a menu screen of communication setting, which is displayed when communication setting is selected on the screen shown in FIG. 3B. In the menu screen of communication setting, “wireless LAN”, “wired LAN”, “wireless direct” “Bluetooth”, and “common” are displayed as menu items (options). The “wireless LAN”, “wired LAN”, and “wireless direct” are menu items relating to LAN settings and can be used to select wired connection setting, make the wireless infrastructure mode effective or non-effective, or make a P2P mode such as a WFD mode or a soft AP mode effective or non-effective. When the item “wireless LAN” is selected to make the wireless LAN effective through a user operation, the wireless infrastructure mode becomes effective. When the item “wireless direct” is selected to make wireless direct effective through a user operation, the P2P (WLAN) mode becomes effective. Also, a common setting menu relating to each connection type is displayed in this screen. Furthermore, the user can set a frequency band and a frequency channel of the wireless LAN via this screen.

### External Configuration of Portable Terminal Device

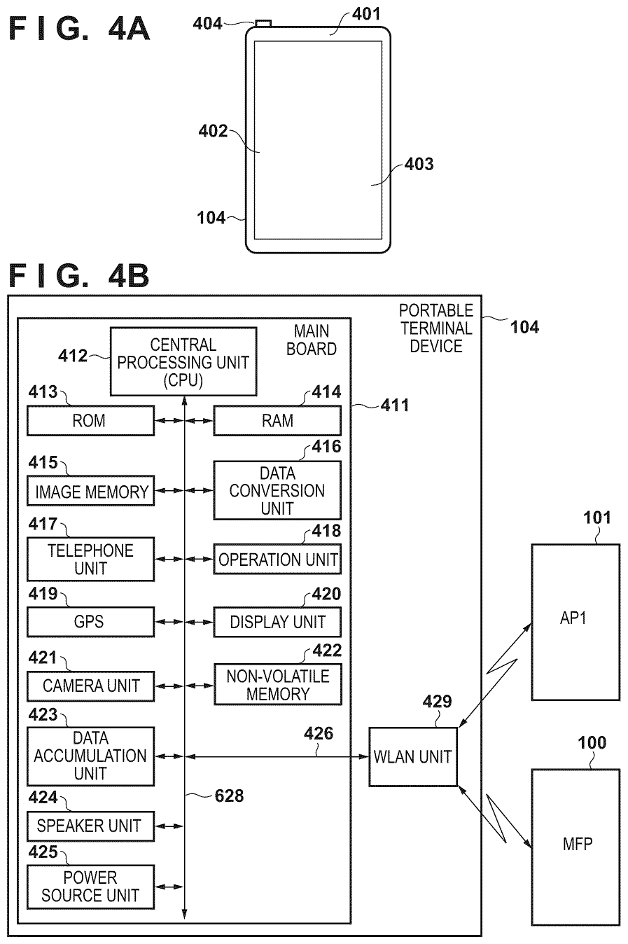

FIG. 4A is a diagram showing an example of an external configuration of the portable terminal device 104. In the present embodiment, a case where the portable terminal device 104 is a common smartphone is shown as an example. Note that the portable terminal device 104 includes a display unit 402, an operation unit 403, and a power source key 404, for example. The display unit 402 is a display including a display mechanism of liquid crystal display (LCD), for example. Note that the display unit 402 may also display information by using light emitting diodes (LEDs), for example. The portable terminal device 104 may also have a function of outputting information by using audio in addition to or instead of the display unit 402. The operation unit 403 includes a hardware key such as a key or a button, a touch panel, and the like for detecting user operations. Note that, in this example, a common touch panel display is used by the display unit 402 to display information and by the operation unit 403 to accept user operations, and accordingly, the display unit 402 and the operation unit 403 are realized by a single device. In this case, button icons and a software keyboard are displayed with use of a display function of the display unit 402, and a touch made by the user on any of these positions is detected by an operation accepting function of the operation unit 403, for example. Note that a configuration is also possible in which the display unit 402 and the operation unit 403 are separated from each other, and hardware used for display and hardware used for accepting operations may be prepared separately. The power source key 404 is a hardware key for accepting a user operation for turning the power source of the portable terminal device 104 on or off.

The portable terminal device 104 includes the WLAN unit 401 that provides a WLAN communication function, although the WLAN unit does not necessarily have to be visible from the outside. The WLAN unit 401 is configured to be capable of executing data (packet) communication in a WLAN system in accordance with the IEEE 802.11 standard series (e.g., IEEE 802.11a/b/g/n/ac/ax), for example. Also, the WLAN unit 401 can perform communication as an AP that supports Wi-Fi Agile Multiband (trademark). However, there is no limitation to this configuration, and the WLAN unit 401 may also be capable of executing communication in a WLAN system in accordance with another standard. In this example, the WLAN unit 401 can perform communication in both the 2.4 GHz band and the 5 GHz band. Also, the WLAN unit 401 can perform communication based on WFD, communication in the soft AP mode, and communication in the wireless infrastructure mode, for example. Operations in these modes will be described later.

### Configuration of Portable Terminal Device

FIG. 4B shows an example configuration of the portable terminal device 104. In an example, the portable terminal device 104 includes a main unit 411 that performs main control of the portable terminal device 104 and a WLAN unit 429 that performs WLAN communication. The main unit 411 is simply a unit that includes functional blocks other than the WLAN unit 429. The main unit 411 includes a CPU 412, a ROM 413, a RAM 414, an image memory 415, a data conversion unit 416, a telephone unit 417, a GPS 419, a camera unit 421, a non-volatile memory 422, a data accumulation unit 423, a speaker unit 424, and a power source unit 425, for example. Here, CPU is an acronym of Central Processing Unit, ROM is an acronym of Read Only Memory, RAM is an acronym of Random Access Memory, and GPS is an acronym of Global Positioning System. Also, the portable terminal device 104 includes a display unit 420 and an operation unit 418. These functional units included in the main unit 411 are connected to each other via a system bus 628 controlled by the CPU 412. Also, the main unit 411 and the WLAN unit 429 (the WLAN unit 401 described above) are connected via a dedicated bus 426, for example.

The CPU 412 is a system control unit including at least one processor and controls the entire portable terminal device 104. Processing performed by the portable terminal device 104 described below is realized by the CPU 412 by executing a program stored in the ROM 413, for example. Note that dedicated hardware may also be prepared for each process. Control programs executed by the CPU 412, an embedded operating system (OS) program, and the like are stored in the ROM 413. In the present embodiment, the CPU 412 performs software control such as scheduling and task switching by executing each control program stored in the ROM 413 under management of an embedded OS, which is also stored in the ROM 413.

The RAM 414 is constituted by a static RAM (SRAM), for example. Data such as program control variables, setting values registered by the user, and data such as management data of the portable terminal device 104 are stored in the RAM 414. The RAM 414 may also be used as a buffer for various works. The image memory 415 is constituted by a memory such as a dynamic RAM (DRAM). Image data received via the WLAN unit 429 and image data read out from the data accumulation unit 423 are temporarily stored in the image memory 415 to be processed by the CPU 412. The non-volatile memory 422 is constituted by a memory such as a flash memory, for example, and keeps data stored therein even when the power source of the portable terminal device 104 is turned off. Note that the memory configuration of the portable terminal device 104 is not limited to the above configuration. For example, the image memory 415 and the RAM 414 may be configured as a common memory, and the data accumulation unit 423 may be used for data backup or the like. Also, DRAM is described as an example of the image memory 415 in the present embodiment, but another storage medium such as a hard disk or a non-volatile memory may also be used as the image memory 415.

The data conversion unit 416 performs analysis of data in various forms and data conversion such as color conversion and image conversion. The telephone unit 417 realizes telephone communication by controlling a telephone line and processing audio data that is input or output via the speaker unit 424. The GPS 419 obtains positional information such as the current latitude and longitude of the portable terminal device 104 by receiving radio waves transmitted from satellites.

The camera unit 421 has a function of electronically recording and encoding an image input through a lens. Image data obtained by the camera unit 421 by capturing an image is stored in the data accumulation unit 423. The speaker unit 424 performs control to realize a function of inputting or outputting audio for the telephone function and an alarm function, for example. The power source unit 425 is a portable battery, for example, and performs control to supply power to the portable terminal device. Power source sates include a battery run-down state in which the battery level is 0, a power off state in which the power source key 404 has not been pressed, a booted state in which the portable terminal device has been normally booted, and a power saving state in which the portable terminal device has been booted but power consumption is saved.

The display unit 420 is the display unit 402 described with reference to FIG. 4A and accepts various input operations and displays operating conditions and status conditions of the MFP 100 under control performed by the CPU 412. The operation unit 418 is the operation unit 403 described with reference to FIG. 4A and, upon accepting a user operation, executes control for generating an electrical signal corresponding to the operation and outputting the signal to the CPU 412, for example.

The portable terminal device 104 performs wireless communication by using the WLAN unit 429 to perform data communication with another device such as the MFP 100. The WLAN unit 429 converts data to a packet and transmits the packet to another device. Also, the WLAN unit 429 restores original data from a packet received from an external device and outputs the data to the CPU 412. The WLAN unit 429 is a unit for realizing communication in accordance with each WLAN standard. The WLAN unit 429 can operate in parallel in at least two communication modes including the wireless infrastructure mode and the P2P (WLAN) mode. Note that frequency bands used in these communication modes may be limited due to functions and performance of hardware.

### Configuration of Access Point

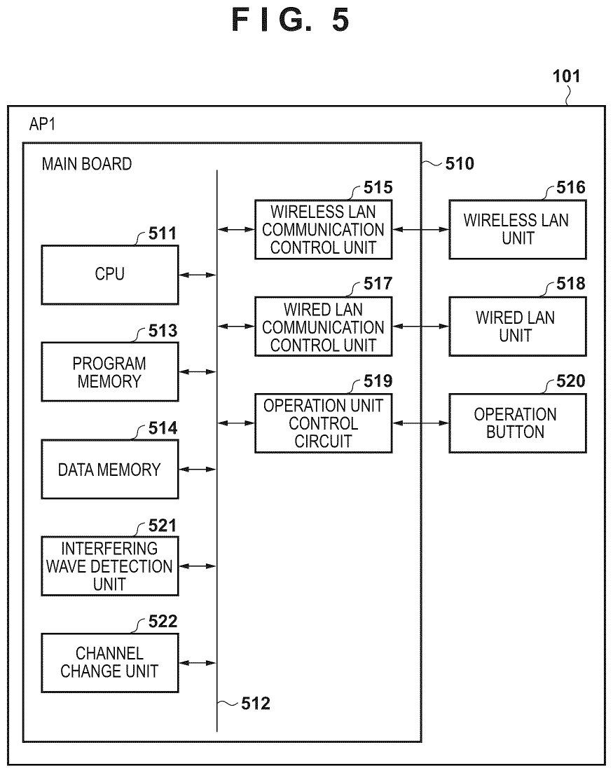

FIG. 5 is a block diagram showing a configuration of the AP 101 that has a wireless LAN access point function. The AP 101 includes a main unit 510 that controls the AP 101, a wireless LAN unit 516, a wired LAN unit 518, and an operation button 520. The main unit 510 is simply a unit that includes functional blocks other than the wireless LAN unit 516, the wired LAN unit 518, and the operation button 520.

A CPU 511, which is a microprocessor included in the main unit 510, operates in accordance with a control program stored in a program memory 513, which is a ROM connected to the CPU 511 via an internal bus 512, and contents in a data memory 514, which is a RAM. The CPU 511 controls the wireless LAN unit 516 via a wireless LAN communication control unit 515 to perform wireless LAN communication with another communication terminal device. Also, the CPU 511 controls the wired LAN unit 518 via a wired LAN communication control unit 517 to perform wired LAN communication with another communication terminal device. The CPU 511 can accept an operation made on the operation button 520 by a user by controlling an operation unit control circuit 519. The CPU 511 includes at least one processor.

The AP 101 also includes an interfering wave detection unit 521 and a channel change unit 522. The interfering wave detection unit 521 performs processing for detecting an interfering wave while wireless communication is performed in a range in which dynamic frequency selection (DFS) is performed. If an interfering wave is detected while wireless communication is performed in a range in which DFS is performed, the channel change unit 522 performs processing for changing a current channel to a channel that is used when it is necessary to immediately change the channel used to an available channel, for example.

Note that the AP 102 is configured similarly to the AP 101.

### P2P Communication Method

Next, the following describes an outline of a P2P (WLAN) communication method in which devices directly perform wireless communication with each other not via an external access point in WLAN communication. The P2P (WLAN) communication can be realized with use of a plurality of methods. For example, a communication device can support a plurality of modes for the P2P (WLAN) communication and execute the P2P (WLAN) communication by selectively using any of the plurality of modes.

The following two modes are conceivable as P2P modes.
Soft AP mode
Wi-Fi Direct (WFD) mode

A communication device that can execute the P2P communication may be configured to support at least one of these modes. On the other hand, even if a communication device can execute the P2P communication, the communication device need not support all of these modes and may be configured to support only some of these modes.

In a communication device (e.g., the portable terminal device 104) having a communication function based on WFD, an application for realizing the communication function (which may be a dedicated application) is called for in response to an operation unit of the communication device accepting a user operation. Then, the communication device may display a screen including a user interface (UI) provided by the application to prompt a user operation and execute WFD communication based on the user operation.

### Soft AP Mode

In the soft AP mode, a communication device (e.g., the portable terminal device 104) operates as a client that requests various services. Another communication device (e.g., the MFP 100) operates as a soft AP that can execute functions of an AP in the WLAN in accordance with a setting set by software. Note that it is sufficient to use commands and parameters defined in Wi-Fi (registered trademark) standards, as commands and parameters transmitted to establish a wireless connection between the client and the soft AP, and accordingly, descriptions thereof are omitted. Also, the MFP 100 operating in the soft AP mode determines, as a master station, a frequency band and a frequency channel. Therefore, the MFP 100 can select a frequency band to be used from the 5 GHz band and the 2.4 GHz band, and a frequency channel to be used in the selected frequency band.

### WFD Mode

The MFP 100 may be booted always as a master station (autonomous group owner) in the WFD mode. In this case, there is no need to perform GO negotiation processing for determining roles. Also, in this case, the MFP 100 determines, as the master station, a frequency band and a frequency channel. Therefore, the MFP 100 can select a frequency band to be used from the 5 GHz band and the 2.4 GHz band, and a frequency channel to be used in the selected frequency band.

### Wireless Infrastructure Mode

In the wireless infrastructure mode, communication devices (e.g., the portable terminal device 104 and the MFP 100) that perform communication with each other are connected to an external AP (e.g., the AP 101) that supervises a network, and communication between the communication devices is performed via the AP. In other words, communication between the communication devices is executed via a network established by the external AP. The portable terminal device 104 and the MFP 100 each find the AP 101 and transmit a connection request to the AP 101 to be connected to the AP 101, and thus communication between these communication devices can be performed via the AP 101 in the wireless infrastructure mode. Note that the plurality of communication devices may also be connected to different APs. In this case, communication between the communication devices can be performed through data transfer between the APs. It is sufficient to use commands and parameters defined in the Wi-Fi standards, as commands and parameters transmitted to perform communication between the communication devices via the access point, and accordingly, descriptions thereof are omitted. Also, in this case, the AP 101 determines a frequency band and a frequency channel. Therefore, the AP 101 can select a frequency band to be used from the 5 GHz band, the 2.4 GHz band, and the 6 GHz band, and a frequency channel to be used in the selected frequency band.

### Processing Performed in Response to Connection Destination Change Request from AP to STA

The portable terminal device 104 and the MFP 100 support a function that is made open to the public as Wi-Fi Agile Multiband (trademark). The Wi-Fi Agile Multiband is a function that makes it possible to select the optimum environment according to changing conditions of a Wi-Fi network. Specifically, STAs such as the portable terminal device 104 and the MFP 100 and an AP such as the AP 101 exchange information regarding the network environment with use of communication standards included in the IEEE 802.11 series. Through this information exchange, the AP can guide the STAs (cause the STAs to change the connection destination) to another AP, another frequency band or channel, or another cellular service in some cases, when the network is congested.

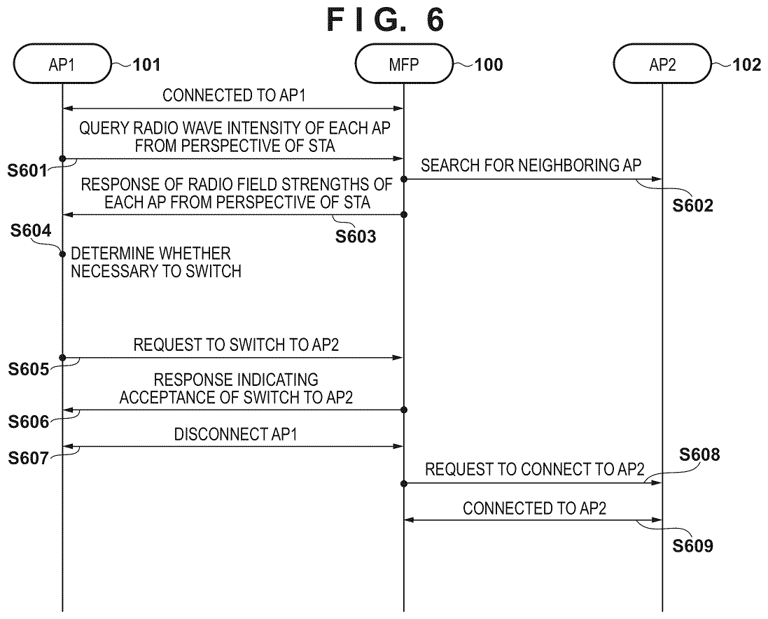

FIG. 6 is a sequence diagram showing a case where the MFP 100 switches the connection destination AP from the AP 101 to the AP 102 in accordance with a connection destination change request (a change request of an access point serving as a connection destination) from the AP 101. Processing executed by each apparatus in this sequence is realized by the CPU included in the apparatus by loading various programs stored in a memory such as a ROM included in the apparatus into a RAM included in the apparatus and executing the programs.

In the initial state of the processing shown in FIG. 6, the MFP 100 has established a connection with the AP 101 in the wireless infrastructure mode. Also, the AP 101 has obtained information indicating whether or not the MFP 100 supports IEEE 802.11v when the connection was established between the MFP 100 and the AP 101 in the wireless infrastructure mode. The following processing is performed in a case where the AP 101 has obtained information indicating that the MFP 100 supports IEEE 802.11v.

In step S601, the AP 101 transmits an inquiry (measurement request) about intensities of radio waves received from APs located in a surrounding area of the MFP 100 to the MFP 100. This inquiry is transmitted as a beacon frame request or a beacon report request, for example. That is to say, this request can be transmitted with use of a method defined in the IEEE 802.11k standards.

In step S602, the MFP 100 measures radio wave intensities by receiving frames transmitted from the APs located in the surrounding area in response to the request received in step S601. Thus, intensities of radio waves received from the plurality of APs including the AP 101 and the AP 102 are measured.

In step S603, the MFP 100 transmits a list of the intensities of radio waves received from the APs located in the surrounding area of the MFP 100, which are measured in step S602, as a response to the request received in step S601. Note that information stored in the RAM 214 and the non-volatile memory 215 of the MFP 100 may be included as radio wave intensities in the response in addition to or instead of the information measured in step S602. This response is transmitted as a beacon report or a measurement report, for example.

In step S604, the AP 101 determines whether or not the connection destination of the MFP 100 needs to be switched based on a congestion state of the network recognized by the AP 101 and the radio wave intensities received from the MFP 100 in step S603. The AP 101 determines that the connection destination needs to be switched when the number of STAs connected to the AP 101 is large, the communication traffic volume is large, another AP is less congested than the AP 101, there is an interfering radio wave, or the AP function is stopped, for example. When it is determined that the connection destination of the MFP 100 needs to be switched and SSID of another AP, a channel, or a frequency band designated as a switching destination of the MFP 100 is determined, the processing proceeds to step S605.

In step S605, the AP 101 transmits an AP change request (connection destination change request) to the MFP 100. The connection destination change request includes information indicating the SSID of the other AP, the channel, or the frequency band designated as the switching destination of the MFP 100 determined in step S604. Note that a plurality of SSIDs may be designated. The connection destination change request is transmitted as a BTM request, for example. That is to say, a BSS transition management (BTM) request frame defined in the IEEE 802.11v standards is transmitted. In the example shown in FIG. 6, the AP 102 is designated as the switching destination included in the connection destination change request.

When the MFP 100 obeys the connection destination change request received in step S605, the MFP 100 transmits, to the AP 101, a response indicating approval for the switching in step S606. When the MFP 100 does not obey the connection destination change request, the MFP 100 may transmit a response indicating rejection of the switching. The response is transmitted as a BTM response. In the example shown in FIG. 6, a response indicating approval is transmitted.

In step S607, the connection between the AP 101 and the MFP 100 in the wireless infrastructure mode is cut off.

In step S608, the MFP 100 transmits a connection request to the AP 102 to be connected to the AP 102, which is designated in the connection destination change request received in step S605.

As a result, a connection is established between the MFP 100 and the AP 102 in the wireless infrastructure mode in step S609.

As described above, the MFP 100 operating as a STA can change the connection destination from the AP 101 to the AP 102 based on a connection destination change request from the AP 101 to which the MFP 100 is originally connected. The AP 101 and the AP 102 may be APs installed at different locations. That is to say, through the processing shown in FIG. 6, the MFP 100 can switch the connection destination to another AP installed at a location different from the location of the AP to which the MFP 100 is originally connected. Alternatively, the AP 101 and the AP 102 may be APs respectively corresponding to different frequency bands among a plurality of frequency bands (two or three of the 2.4 GHz band, the 5 GHz band, and the 6 GHz band) provided by the same apparatus. That is to say, through the processing shown in FIG. 6, the MFP 100 can switch the connection destination to another frequency band provided by the same apparatus as the AP to which the MFP 100 is originally connected. For example, it is possible to switch the connection destination to an AP corresponding to the 6 GHz band based on the connection destination change request.

Note that, in the present embodiment, a case is described as an example in which a measurement request and a connection destination change request are transmitted from an AP with use of a method in accordance with Wi-Fi Agile Multiband, and the STA responds to these requests, but there is no limitation to this example. The present embodiment is also applicable to a case where the STA makes a response and changes the connection destination AP (switches, deletes, or adds the connection destination AP) in response to a measurement request and a connection destination change request transmitted from an AP with use of a method other than that used in the above example.

There are situations in which no problem occurs even when the connection destination AP is changed based on a connection destination AP change request transmitted from the currently connected AP and situations in which it is not desirable to change the connection destination AP. In those situations in which it is not desirable to change the connection destination AP based on the change request, one or a combination of two or more of the following types of processing can be performed as processing for suppressing change of the connection destination in response to the change request. Each of the following types of processing is processing for avoiding change of the connection destination AP based on the change request or processing for suppressing change of the connection destination AP.

### Suppression Processing 1

Even when the change request described in connection with step S605 is received, the connection destination AP is not changed based on the received change request, and no response is made for the change request or a response indicating rejection (not to change the connection destination AP) is transmitted to the currently connected AP in response to the change request. In the case where a response indicating rejection is transmitted, a priority level of change of the connection destination of another STA that is connected to the AP to which the MFP 100 is connected becomes higher, and a priority level of change of the connection destination of the MFP 100, which has transmitted the response indicating rejection, becomes lower, and consequently, the MFP 100 may be able to maintain the connection with the currently connected AP. In the case where no response is made (the request is ignored), it is thought that the currently connected AP will maintain the connection with the MFP 100 because the AP waits for a response until a response waiting time expires. Accordingly, in a situation in which the connection is immediately cut off upon any response to the change request being received from the MFP 100, it is possible to maintain the connection with the currently connected AP longer in the case where no response is made than in the case where any response is made. Therefore, different types of processing may be performed based on information indicating a reason of the change is included in the change request. For example, a response indicating rejection may be transmitted if the reason is weak, and the change request may be ignored if the reason is strong. The reason of the change can be determined based on information indicating a reason among a plurality of reasons included in a request mode in the BTM request, for example. For example, when a disassociation imminent bit or a BSS termination included bit in the request mode is 1, it can be determined that the reason of the change is strong. Otherwise, it can be determined that the reason of the change is weak.

### Suppression Processing 2

In response to the measurement request described in connection with step S601, information indicating that radio wave reception conditions (signal reception conditions) of non-connected APs other than the currently connected AP are worse than actually measured conditions (i.e., signal quality is worse than actually measured signal quality) is given as a response (false response). In this case, the response may be made by actually performing measurement in response to the received measurement request, or the response may be made without measurement being actually performed. Specifically, in the response (e.g., beacon report) described in connection with step S603, values obtained by reducing received signal intensities or/and increasing the noise (signal-to-noise ratio) are given as signal qualities measured for signals received from the non-connected APs. Alternatively, information regarding at least one non-connected AP may be kept from being included in the response. Alternatively, it is possible to perform processing for making a response indicating significantly low received signal intensities or a response indicating values obtained by significantly increasing the noise, based on information measured in the past regarding the non-connected APs. Alternatively, it is possible to make a response indicating that a favorable received signal intensity and favorable noise conditions can be obtained only for the currently connected AP, without measurement (AP search) being actually performed and information regarding the non-connected APs being included in the response, even if the measurement request is received. Giving a response not including information regarding the non-connected APs in response to the measurement request corresponds to giving a response indicating that any other non-connected APs cannot be found through the AP search. That is to say, the response not including information regarding the non-connected APs indicates that at least some signal qualities of signals received from the non-connected APs are worse than signal qualities obtained when the AP search is actually performed.

In this case, it is expected that a request to change the connection destination to another AP will be kept from being transmitted from the currently connected AP. Accordingly, change of the connection destination in response to the connection destination change request is suppressed.

### Suppression Processing 3

The connection with the currently connected AP is temporarily cut off, and a connection is again established with the same AP after giving information indicating that the MFP does not support the change request. Specifically, the wireless connection with the currently connected AP is temporarily cut off, and data of an association request frame including information indicating that the MFP does not support IEEE 802.11v is generated as preparation for establishing the wireless connection again. Thereafter, processing for establishing a connection to the AP is performed with use of the generated data of the association request frame. Consequently, in the case where the association request frame including the information indicating that the MFP does not support IEEE 802.11v is generated, the MFP is connected to the AP as an electronic apparatus that does not support the function of Agile Multiband. Consequently, the connected AP recognizes the MFP 100 as an electronic apparatus that does not support IEEE 802.11v and no longer transmits a request for changing the destination of wireless connection to the MFP 100. Since a request for changing the destination of wireless connection is no longer transmitted to the MFP 100, the wireless connection between the MFP 100 and the currently connected AP is likely to be maintained. Also, when the MFP 100 is recognized as an electronic apparatus that does not support IEEE 802.11v by the currently connected AP, transmission of the measurement request (the request described in connection with step S601) from the currently connected AP to the MFP 100 is also suppressed. Therefore, the MFP 100 can be kept from performing measurement (AP search) in response to the measurement request and giving a response to the measurement request (processing in step S603). Accordingly, it is possible to reduce a processing load, save power consumption, and apply resources to other processing.

It is not preferable to change the connection destination AP based on the change request in a state where print data is being received, for example. The state where print data is being received by the MFP 100 is a state where a portion of print data of an image that is to be printed has been received from the portable terminal device 104 and the remaining portion of the print data has not been received. The MFP 100 does not store all print data to be printed on a single sheet. Therefore, upon receiving a portion of the print data, the MFP 100 performs printing of the received data (e.g., receives print data corresponding to a line, and performs printing of that line), and repeatedly performs reception and printing of the following data. If the connection destination AP is changed based on the connection destination change request while the print data is being received as described above, a time lag due to connection destination switching processing occurs and this may lead to degradation of printing quality such as uneven printing. Also, a situation may occur in which a problem occurs in communication with the portable terminal device 104 after the connection destination is switched, and the following data cannot be received, resulting in a printing failure. Therefore, while printing data is being received, it is preferable to perform at least one of the suppression processing 1 and the suppression processing 2 described above as processing for suppressing change of the connection destination in response to the change request or perform the suppression processing 3 described above before reception of the print data is started.

Likewise, it may not be preferable to change the connection destination AP based on the change request depending on a security state set in the MFP 100. The following describes a configuration for performing control to change the connection destination AP or suppress the change by the MFP 100 based on security settings set in the MFP 100.

### Security Settings of MFP 100

An electronic apparatus connected to a network is exposed to security risks. Accordingly, various settings relating to security need to be made appropriately. For example, the MFP 100, which is a multifunction printer that performs copying, printing, scanning, etc., of images, may be used in various environments such as a large office, a small office, a public space, or a home working environment. Therefore, security settings corresponding to various risk levels are prepared for the MFP 100. These types of security settings include many items, and those items include items that are difficult to set for a user who does not have technical knowledge about security. Therefore, the MFP 100 in the present embodiment may have a function for collectively setting a plurality of security setting items based on a selected security type. Examples of a method for selecting a security type include a method of selecting a use environment type corresponding to an environment in which the MFP 100 is installed and a method of selecting a security level indicating the intensity of security of the MFP 100.

### Method for Setting Security Settings by Selecting Use Environment Type

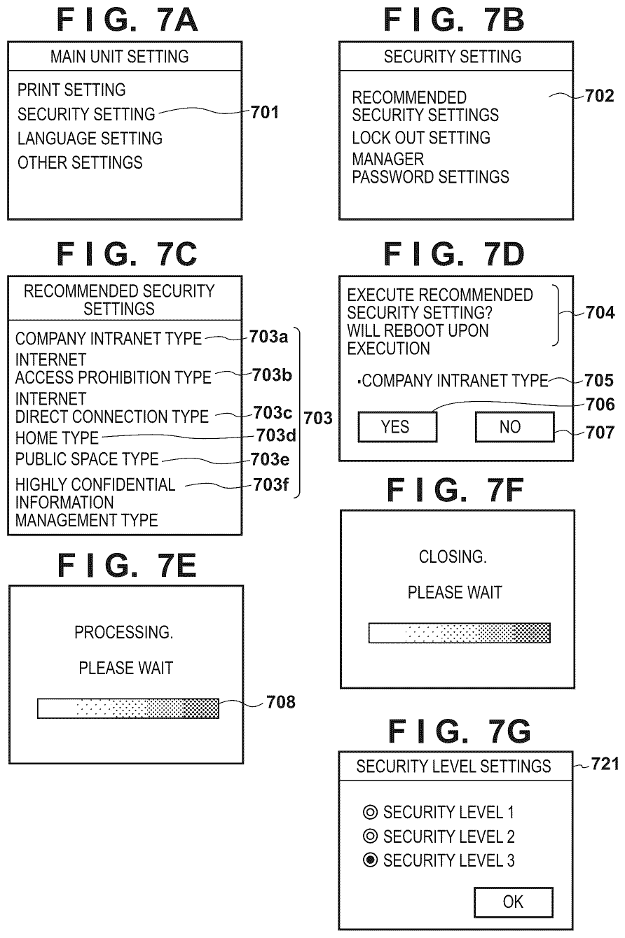

FIGS. 7A to 7G show examples of screens displayed in the operation display unit 205 of the MFP 100 for operations relating to the function for collectively setting security setting values of the apparatus main unit. FIG. 7A shows a “main unit setting” screen that is displayed when “main unit setting” is selected on the screen shown in FIG. 3B. This screen shows “print setting”, “security setting”, “language setting”, and “other settings” as further selection items. FIG. 7B shows a security setting screen that is displayed when security setting 701 is selected from the selection items on the screen shown in FIG. 7A. This screen shows “recommended security settings”, “lock out setting”, and “manager password setting” as further selection items.

FIG. 7C shows a “recommended security settings” screen that is displayed when recommended security settings 702 is selected on the screen shown in FIG. 7B. The illustrated screen shows six use environment types (a company intranet type 703a, an Internet access prohibition type 703b, an Internet direct connection type 703c, a home type 703d, a public space type 703e, and a highly confidential information management type 703f) as example options 703 of a security type set in the MFP 100.

FIG. 7D shows a confirmation screen that is displayed after any of the use environment types is selected on the screen shown in FIG. 7C and before security setting (collective setting) corresponding to the selected use environment type is executed. A message 704 is displayed to make a final confirmation before execution of the collective setting and indicates that the MFP 100 will be automatically rebooted after execution of the collective setting. A security type 705 corresponds to the environment type selected by the user on the previous screen (FIG. 7C) and indicates that the company intranet type 703a has been selected in the example shown in FIG. 7D. An “yes” button 706 for allowing execution of the security setting and a “no” button 707 for canceling execution of the security setting are provided in a lower part of the screen.

FIG. 7E shows a processing screen that is displayed after the “yes” button 706 is selected by the user on the screen shown in FIG. 7D. An indicator 708 indicates that internal processing is progressing in the MFP 100. At this time, a plurality of security setting items are collectively set in the MFP 100 according to the selected use environment type, and setting values are stored together with the selected security type in the RAM 214 and the non-volatile memory 215. When the series of processing is complete, the MFP 100 displays an ending screen shown in FIG. 7F, shuts down, and thereafter is automatically rebooted. As described above, the MFP 100 has the function for collectively setting a plurality of security related setting values to values that are suitable for the use environment by letting the user select the use environment in which the MFP 100 is installed, as the “security type”.

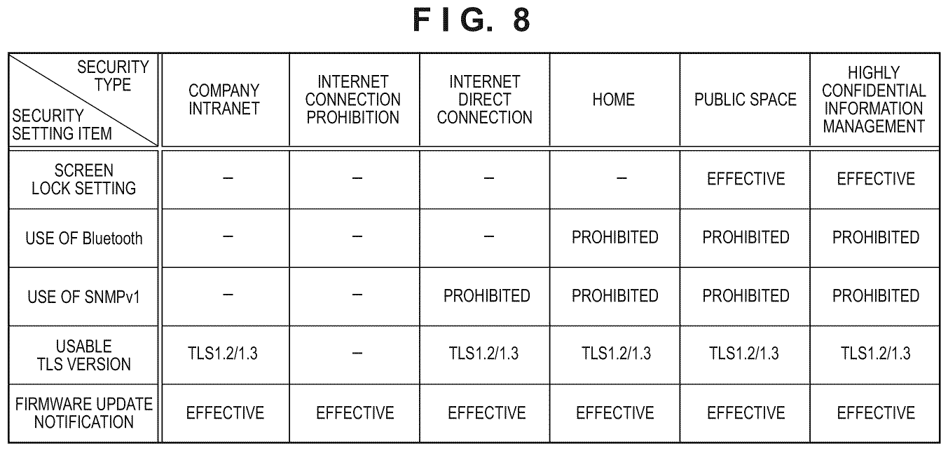

FIG. 8 shows a correspondence table showing security setting values that are set by the collective setting function of the MFP 100 according to each use environment type. The top row in the table shown in FIG. 8 shows use environment types that are set as security types and include the company intranet type, the Internet access prohibition type, the Internet direct connection type, the home type, the public space type, and the highly confidential information management type as described above.

The leftmost column in the table shown in FIG. 8 shows security setting items of the MFP 100, which are collectively set. “Screen lock setting” represents a function for preventing an unauthorized operation made by a person other than the authorized user and information leakage by switching a screen (locking a screen) to a screen requiring entry of a password, when no operation has been made on the operation display unit 205 for a certain period of time. “Use of Bluetooth” represents a setting regarding whether or not to prohibit access from an external apparatus through Bluetooth communication. “Use of SNMPv1” represents a setting regarding whether or not to prohibit communication in a specific version (in this example, version 1) of the simple network management protocol (SNMP). “Usable TLS version” represents a setting regarding usable versions of transport layer security (TLS), which is an encrypted communication protocol used in a server function of the MFP 100. “Firmware update notification” represents a setting regarding whether or not to make a function effective to prompt the user to update firmware by displaying a message on the operation display unit 205 when there is an updated version of firmware included in the MFP 100.

Each of the security setting items can be individually set from the main unit setting menu or the communication setting menu on the operation display unit 205, but it is also possible to collectively set the security setting items by selecting a security type (in this example, a use environment type). In the case of collective setting, the security setting items are respectively set to setting values shown in the table according to the selected security type. Note that hyphens “-” shown in the table indicate that setting values set when the MFP 100 is shipped from a factory or setting values set by the user after the shipment are not changed. That is to say, states immediately before execution of collective setting (i.e., setting values set when the MFP is shipped from the factory or setting values set by the user) are maintained.

The following describes the use environment types. The Internet access prohibition type corresponds to a security setting that is suitable for the use of the MFP 100 in an environment that is isolated from the Internet. The company intranet type corresponds to a security setting that is suitable for the use of the MFP 100 in an intranet environment managed by a company or the like. The Internet direct connection type corresponds to a security setting that is suitable for the use of the MFP 100 in an environment in which the MFP is directly connected to the Internet. The home type corresponds to a security setting that is suitable for the use of the MFP 100 in a home network (home LAN) environment managed by an individual. The public space type corresponds to a security setting that is suitable for the use of the MFP 100 in an environment in which the MFP is used by an unspecified large number of people or in a public network environment. The highly confidential information management type corresponds to a security setting that is suitable for the use of the MFP 100 in an environment where there is a significant influence when an attack or information leakage occurs. In the security setting corresponding to the Internet access prohibition type, priority is given to connectability in the isolated network, and accordingly, only fundamental security measures are executed so that use of an information apparatus with use of a conventional cipher or protocol will not be restricted, for example. As shown in the correspondence table in FIG. 8, the security items are set such that the security level becomes higher in the following order: the Internet access prohibition type, the company intranet type, the Internet direct connection type, the home type, the public space type, and the highly confidential information management type. As for the highly confidential information management type, the highest priority is given to security, and functions for which even a small risk is conceivable are all restricted.

Out of the security setting items, the screen lock setting is a setting for locking a displayed operation screen to restrict printer operations made by the user and requiring the user to enter a password. When the screen lock setting is made effective, security is improved, but additional operations are required. Therefore, in the present embodiment, the screen lock setting is made effective only for the public space type for which the use of the MFP by an unspecified large number of users is envisaged and the highly confidential information management type for which a very high security level is required. When use environment types other than these two use environment types are selected, the screen lock setting is not positively made “effective” by the collective setting function, and a current setting value is maintained (as shown by “- (hyphen)” in FIG. 8). Also, as for the setting regarding the use of Bluetooth, “prohibit” is set in the collective setting for the home type, the public space type, and the highly confidential information management type, which are use environments in which a security risk may arise through Bluetooth communication. The setting regarding usable TLS version limits versions of TLS, which are security methods for network communication. In addition to “TLS1.2/1.3” shown in FIG. 8, the versions of TLS include TLS1.0 and TLS1.1, but these versions are old and include security risks. Accordingly, as shown in FIG. 8, the usable TLS version is set to TLS1.2/1.3 in the collective setting for use environments other than the “Internet access prohibition type”. In a use environment corresponding to the “Internet access prohibition type”, the MFP is not connected to the Internet, and accordingly, the use of TLS1.0/1.1 may be allowed, and therefore, “hyphen (-)” is shown in the table.

Note that security setting items that are set according to each security type are not limited to those described above. For example, the security setting items may also include usable encryption schemes (3DES, AES, AES-GCM, etc.) and usable hash functions (SHA-1, SHA-2, etc.) for respective security types. Furthermore, the security setting items may also include settings regarding whether or not each of IPP security, HTTPS security, and Enhanced WSD security needs to be used for each security type. Note that the security items described above do not limit security setting items that are collectively set, and also, there is no need to collectively set all of the security items described above.

Note that these security setting items include an item that requires a related processing unit to be reset to make the changed setting value effective. Therefore, when the security type (in this example, the use environment type) is changed, the MFP 100 is automatically rebooted, and setting values are applied after the reboot. Also, the user may select none of the security types, i.e., the user may select not to use the security collective setting function.

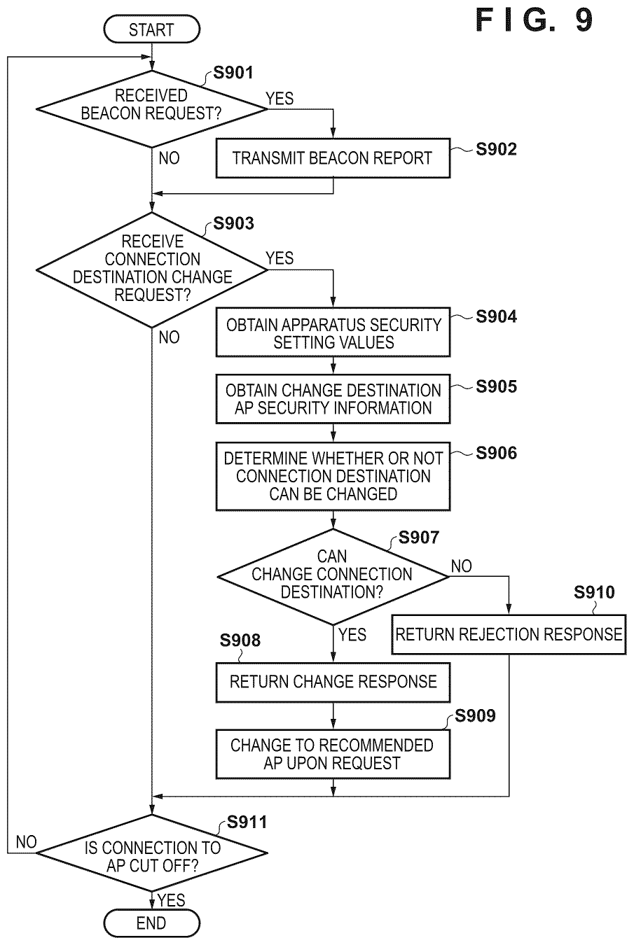

FIG. 9 is a flowchart showing processing performed by the MFP 100 in response to a connection destination AP change request according to the state (set security state) of the MFP 100. Processing executed by the MFP 100 in this flowchart is realized by the CPU 212 by loading various programs stored in a memory such as the ROM 213 into the RAM 214 and executing the programs.

In the initial state of the processing shown in FIG. 9, the MFP 100 has established a connection with the AP 101 in the wireless infrastructure mode. Also, the AP 101 obtains information indicating whether or not the MFP 100 supports IEEE902.11v when the connection is established between the MFP 100 and the AP 101 in the wireless infrastructure mode. In this example, the AP 101 has obtained information indicating that the MFP 100 supports IEEE902.11v, makes an inquiry about radio wave intensities and gives a connection destination AP change request to the MFP 100.

In step S901, the CPU 212 of the MFP 100 determines whether or not an inquiry (measurement request) about intensities of radio waves received from APs located in a surrounding area of the MFP 100 has been received from the AP 101. This inquiry is transmitted as a beacon frame request or a beacon report request. The inquiry about radio wave intensities of which reception is confirmed in this step corresponds to the inquiry transmitted by the AP 101 in step S601 shown in FIG. 6. When the CPU 212 determines that the inquiry about radio wave intensities has been received (YES in step S901), the processing proceeds to step S902. On the other hand, when the CPU 212 determines that the inquiry about radio wave intensities has not been received (NO in step S901), the processing proceeds to step S903. In step S902, the CPU 212 measures intensities of radio waves received from the APs located in the surrounding area of the MFP 100, and transmits a list of the intensities of radio waves received from the APs as a beacon report to the AP 101 as described in connection with steps S602 and S603 shown in FIG. 6.

In step S903, the CPU 212 determines whether or not a connection destination AP change request transmitted from the AP 101 has been received. The change request corresponds to the request transmitted by the AP 101 in step S605 shown in FIG. 6. When the CPU 212 determines that the change request has been received (YES in step S903), the processing proceeds to step S904. On the other hand, when the CPU 212 determines that the change request has not been received (NO in step S903), the processing proceeds to step S911.

In step S904, the CPU 212 of the MFP 100 obtains security setting values set via the operation screens shown in FIGS. 7A to 7G described above. In this example, the security setting values are stored in the non-volatile memory 215 or the RAM 214, and the CPU 212 reads out the security setting values from the non-volatile memory 215 or the RAM 214. In step S905, the CPU 212 obtains security information regarding an AP (hereinafter referred to as a “switching destination AP”) that is a candidate for a switched connection destination included in the connection destination change request received in step S605 shown in FIG. 6. The security information indicates a security method used in communication between the MFP 100 and the switching destination AP. The security information is included in a robust security network (RSN) information field of a beacon frame received from the switching destination AP. The security information regarding the switching destination AP can be obtained by receiving the beacon frame from the switching destination AP in the processing performed in step S905. Alternatively, security information regarding each AP may be stored in the RAM 214 and the non-volatile memory 215 when the radio wave intensities are obtained in step S902, and the security information regarding the switching destination AP may be read out from the RAM 214 or the non-volatile memory 215.

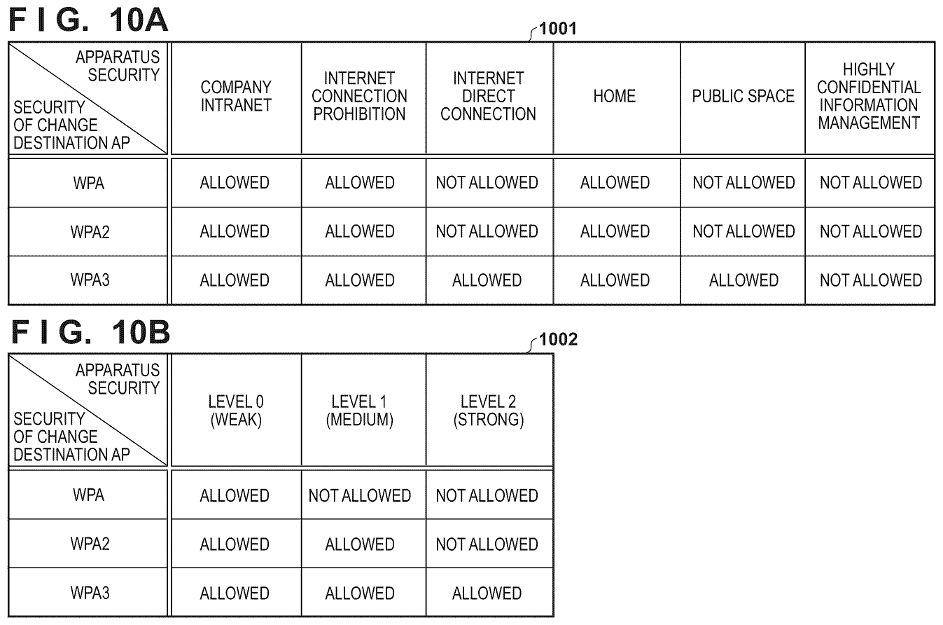

In step S906, the CPU 212 determines whether or not the connection destination AP can be changed based on the security setting values of the MFP obtained in step S904 and the security information regarding the switching destination AP obtained in step S905. This determination will be described later with reference to FIGS. 10A and 10B. In step S907, the CPU 212 causes the processing to branch according to the result of determination performed in step S906. When it is determined by the CPU 212 in step S907 that the connection destination can be changed (YES in step S907), the processing proceeds to step S908, and when it is determined that the connection destination cannot be changed (NO in step S907), the processing proceeds to step S910. In step S908, the CPU 212 transmits a response indicating that the CPU 212 obeys the received connection destination change request, to the AP 101. In step S909, the CPU 212 cuts off the connection to the AP 101 and executes processing for establishing a connection with the connection destination AP included in the connection destination change request. Step S908 corresponds to step S606 shown in FIG. 6, and step S909 corresponds to the processing performed in steps S607, S608, and S609 shown in FIG. 6.

In step S910, the CPU 212 transmits, to the AP 101, a response indicating that the MFP 100 rejects the change in response to the change request, and proceeds to step S911. This processing corresponds to the transmission of a response indicating rejection in step S606 shown in FIG. 6 and corresponds to the suppression processing 1 described above. In step S911, whether or not the connection to the AP 101 is maintained is determined, and if the connection is maintained, the processing proceeds to step S901, and if it is determined that the connection has been cut off, the processing ends.

FIG. 10A shows a determination table 1001 for determining whether or not an AP can be changed based on a security type (use environment type) of the apparatus and security information regarding an AP that is recommended as a switching destination. In step S906, the CPU 212 determines whether or not the connection destination AP can be changed by referring to the determination table 1001 shown in FIG. 10A. The determination table 1001 shows conditions for determining whether or not the connection destination AP can be changed. In the determination table 1001, “security of apparatus” shows a use environment type of the MFP 100 selected by the user. “Security of switching destination AP” shows security information regarding the switching destination AP obtained in step S905, which is WPA, WPA2, or WPA3, for example. WPA3 corresponds to the highest security level, and the security level decreases in the order of WPA2 and WPA. WPA is an abbreviation of Wi-Fi Protected Access. The CPU 212 determines that the connection destination AP can be changed in a case where “allowed” is shown in a cell corresponding to the combination of the security of the apparatus (use environment type) and the security of the switching destination AP in the determination table 1001 shown in FIG. 10A, and determines that the connection destination AP cannot be changed in a case where “not allowed” is shown in the cell. That is to say, a combination of the security of the apparatus and the security of the switching destination AP for which “allowed” is shown in the corresponding cell indicates conditions under which the connection destination AP can be changed in accordance with the change request. Also, a combination of the security of the apparatus and the security of the switching destination AP for which “not allowed” is shown in the corresponding cell indicates conditions under which change of the connection destination AP in accordance with the change request is suppressed. For example, when the security of the apparatus is the company intranet type and the security of the switching destination AP is WPA, it is determined that the connection destination AP can be changed. However, when the security of the apparatus is the public space type, which requires a higher level of security, it is determined that the connection destination AP cannot be changed if the security of the switching destination AP is WPA.

In the configuration described above, whether or not the connection destination AP can be changed is determined according to the use environment type set in the MFP 100. However, a security state used as a basis for determining whether or not the AP can be changed is not limited to the use environment type. For example, the security type may be determined based on a specified security level. In this case, the user selects the security level of the MFP 100 on a screen showing security level options as shown in FIG. 7G, rather than the screen for selecting the use environment type shown in FIG. 7C. Then, in step S906, whether or not the connection destination AP can be changed is determined in accordance with a determination table 1002 shown in FIG. 10B. That is to say, the CPU 212 determines whether or not the AP can be changed based on the security level set in the MFP 100 and security information regarding the switching destination AP by referring to the determination table 1002.

In the determination table 1002, “security of apparatus” shows the security level of the MFP 100 selected by the user. The security level indicates the intensity of security, and is expressed by 0, 1, or 2 in this example. The intensity of security is the lowest when the security level is 0, the second lowest when the security level is 1, and the highest when the security level is 2. It is determined that the connection destination AP can be changed in a case where “allowed” is shown in a cell corresponding to the combination of the security of the apparatus and the security of the switching destination AP in the determination table, and it is determined that the connection destination AP cannot be changed in a case where “not allowed” is shown in the cell. For example, when the security of the apparatus is Level 0 and the security of the switching destination AP is WPA, the CPU 212 determines that the connection destination AP can be changed. Also, when the security of the apparatus is Level 2 and the security of the switching destination AP is WPA, the CPU 212 determines that the connection destination AP cannot be changed.

As described above, a “use environment type” or a security level can be selected as a security type. However, as long as the security type is a setting value with which it possible to specify collective setting of setting items relating to security of the apparatus, there is no limitation on the security type and a method for specifying the security type.

According to the determination table 1001 shown in FIG. 10A, in the case of the highly confidential information management type, the connection destination AP cannot be changed irrespective of the security information regarding the switching destination AP. When a security type that prohibits change of the connection destination AP irrespective of security of the switching destination AP is set as described above, it is possible to perform control using the suppression processing 2 described above. For example, when a use environment type (in this example, the highly confidential information management type) that prohibits change of the connection destination AP irrespective of security of the switching destination AP is set, the CPU 212 may execute the suppression processing 2 in step S902 shown in FIG. 9. When the suppression processing 2 is executed, a beacon report indicating radio wave conditions (signal quality) worse than actually measured conditions is transmitted, and therefore, transmission of a connection destination change request to the MFP 100 is suppressed.

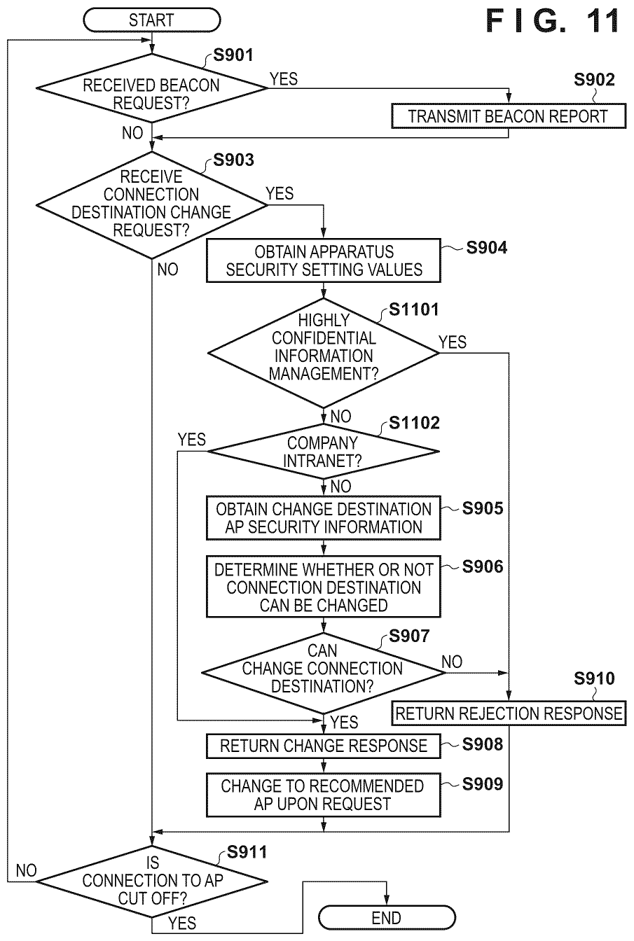

Alternatively, as shown in FIG. 11, when it is determined in step S1101 that the highly confidential information management type is set, the processing may immediately proceed to step S910 and the suppression processing 1 may be executed without security of the switching destination AP being taken into consideration. Also, according to the determination table shown in FIG. 10A, in the case of the company intranet type, the connection destination AP can be changed irrespective of security of the switching destination AP. Accordingly, when it is determined in step S1102 that the company intranet type is set, the processing may immediately proceed to step S908 and the connection destination AP may be changed in accordance with the change request without security of the switching destination AP being taken into consideration. As described above, in the case of the highly confidential information management type and the company intranet type, it is possible to determine whether or not to suppress change of the connection destination without obtaining security of the switching destination AP in step S905 or taking the security of the switching destination AP into consideration.

Furthermore, when a security type that prohibits change of the connection destination AP irrespective of security of the switching destination AP is set, it is also possible to use the suppression processing 3. As described with reference to FIGS. 7C to 7F, the MFP 100 is rebooted when a security type is set. Therefore, when a security type (in this example, the highly confidential information management type) that prohibits change of the connection destination AP irrespective of security of the switching destination AP is set, the CPU 212 performs control to execute the suppression processing 3 when the MFP is rebooted as described above.

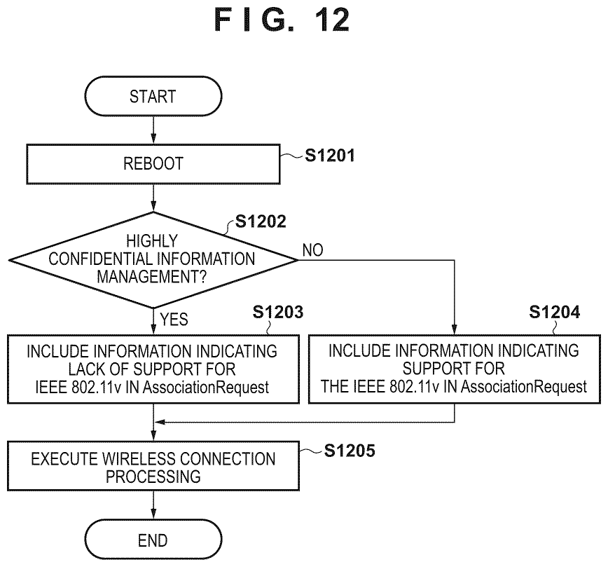

Specifically, this processing can be realized as processing shown in FIG. 12. When the MFP 100 is rebooted in step S1201, the CPU 212 determines whether or not the highly confidential information management type is set as the security type in step S1202. When the CPU 212 determines that the highly confidential information management type is set (YES in step S1202), the processing proceeds to step S1203. In step S1203, the CPU 212 generates an association request frame including information indicating that the MFP does not support IEEE 802.11v. On the other hand, when the CPU 212 determines that the highly confidential information management type is not set (NO in step S1202), the processing proceeds to step S1204. In step S1204, the CPU 212 generates an association request frame including information indicating that the MFP supports IEEE 802.11v. In step S1205, the CPU 212 performs processing for establishing a connection to the AP with use of the association request frame generated in step S1203 or S1204. In the case where the association request frame including the information indicating that the MFP does not support IEEE 802.11v is generated in step S1203, the MFP 100 is connected to the AP as an electronic apparatus that does not support the function of Agile Multiband. Consequently, the connection destination AP change request will no longer be transmitted to the MFP 100. On the other hand, in the case where the association request frame including the information indicating that the MFP supports IEEE 802.11v is generated, the MFP is connected to the AP as an electronic apparatus that supports the function of Agile Multiband.

As described above, in an aspect of the present embodiment, whether or not to suppress change of the connection destination AP is controlled based on only the security type set in the MFP 100.

According to the present embodiment, when a connection destination AP change request is received, it is possible to suppress the occurrence of a situation in which a security risk arises due to the AP being switched based on the change request. That is to say, it is possible to realize both optimization of the connection destination with use of a technology for dynamically switching the connection destination AP and avoidance of security risks for the apparatus.

Note that the various types of control described above as control performed by the CPU included in each apparatus may be performed by a single piece of hardware, or multiple pieces of hardware (e.g., processors or circuits) may share the processing to control the entire apparatus.

Also, preferred embodiments of the present invention have been described in detail, but the present invention is not limited to these specific embodiments and encompasses various forms within a scope not departing from the gist of the present invention. Furthermore, each of the embodiments described above is merely an embodiment of the present invention, and it is also possible to combine the embodiments as appropriate.

Also, a case in which the present invention is applied to a MFP is described as an example in the above embodiments, but the present invention is not limited to this example, and is applicable to a wireless apparatus that is connected to an AP and functions as a STA and that is an electronic apparatus for which security setting can be set. That is to say, the present invention is applicable to a personal computer, a PDA, a tablet terminal, a mobile phone terminal such as a smartphone, a music player, a game player, an electronic book reader, a smart watch, and various measurement devices (sensor devices) such as a thermometer and a hygrometer. Also, the present invention is applicable to a digital camera (including a still camera, a video camera, a network camera, and a security camera), a printer, a scanner, and a drone. Also, the present invention is applicable to a video output device, an audio output device (e.g., a smart speaker), a media streaming player, and a wireless LAN adapter that can be connected to a USB terminal or a LAN cable terminal. The video output device includes a device that obtains (downloads) a moving image on the Internet, which is identified by a URL specified by an electronic apparatus, and outputs the image to a display device connected via a video output terminal such as HDMI (registered trademark), and thus realizes streaming reproduction or mirroring display (displaying contents displayed on the electronic apparatus also on the display device) in the display device, for example. The video output device also includes a television, media players such as a hard disk recorder, a Blu-Ray recorder, and a DVD recorder, a head mounted display, a projector, a television, a display device (monitor), and a signage device. Also, the present invention is applicable to so-called smart home appliances capable of establishing Wi-Fi connection, such as an air conditioner, a refrigerator, a washing machine, a vacuum cleaner, an oven, a microwave oven, a lighting apparatus, a heating apparatus, and an air-cooling apparatus.

The present invention is not limited to the above embodiments, and various changes and alterations can be made without departing from the spirit and scope of the present invention. Therefore, to apprise the public of the scope of the present invention, the following claims are made.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-189526, filed Nov. 6, 2023, which is hereby incorporated by reference herein in its entirety.

What is claimed is:

1. An electronic apparatus comprising at least one memory and at least one processor which function as:
a receiving unit configured to receive a change request of an access point serving as a connection destination from a connected access point;
a setting unit configured to set a setting value relating to security of the electronic apparatus; and
a control unit configured to control whether or not to suppress change of an access point serving as the connection destination based on the change request, based on the setting value set by the setting unit.

2. The electronic apparatus according to claim 1,
wherein, when a first setting value is set by the setting unit, the control unit performs control to change the connection destination based on the change request, and when a second setting value is set by the setting unit, the control unit performs control to suppress the change of the connection destination based on the change request.

3. The electronic apparatus according to claim 1,
wherein the at least one memory and the at least one processor further function as: an obtaining unit configured to obtain a security method used in communication with an access point that is a candidate for a connection destination after the change based on the change request, and
the control unit controls whether or not to suppress the change of the access point serving as the connection destination based on the change request, based on the setting value set by the setting unit and the security method used in communication with the access point that is the candidate for the connection destination.

4. The electronic apparatus according to claim 3,
wherein, when the setting value set by the setting unit and the security method obtained by the obtaining unit satisfy a first condition, the control unit executes the change of the connection destination based on the change request, and when the setting value and the security method satisfy a second condition, the control unit suppresses the change of the connection destination based on the change request.

5. The electronic apparatus according to claim 1,
wherein the at least one memory and the at least one processor further function as: an obtaining unit configured to obtain a security method used in communication with an access point that is a candidate for a connection destination after the change based on the change request, and
when the security method of communication obtained by the obtaining unit is a first method and a first setting value is set by the setting unit, the control unit performs control to change the connection destination based on the change request, and when the security method is the first method and a second setting value is set by the setting unit, the control unit performs control to suppress the change of the connection destination based on the change request.

6. The electronic apparatus according to claim 5,
wherein the first method is Wi-Fi protected access (WPA) or WPA2.

7. The electronic apparatus according to claim 5,
wherein, when the security method of communication obtained by the obtaining unit is a second method that is safer than the first method, the control unit changes the connection destination based on the change request in both of a case where the first setting value is set by the setting unit and a case where the second setting value is set by the setting unit.

8. The electronic apparatus according to claim 7,
wherein the second method is WPA3.

9. The electronic apparatus according to claim 1,
wherein the setting value set by the setting unit indicates a security level of the electronic apparatus.

10. The electronic apparatus according to claim 1,
wherein the setting value set by the setting unit indicates a use environment type of the electronic apparatus.

11. The electronic apparatus according to claim 1,
wherein at least two of the followings are determined based on the setting value set by the setting unit: whether or not to make a function for locking a screen when no operation has been made for a certain period of time effective; whether or not to prohibit use of Bluetooth; whether or not to prohibit use of a specific version of SNMP; a usable version of TLS; whether or not to make firmware update notification effective; a usable encryption scheme; a usable hash function; whether or not IPP security is necessary; whether or not HTTPS security is necessary; and whether or not Enhanced WSD security is necessary.

12. The electronic apparatus according to claim 1,
wherein the electronic apparatus establishes a connection with an access point and performs processing in accordance with IEEE 802.11ax standards.

13. The electronic apparatus according to claim 1,
wherein the electronic apparatus is capable of executing at least one of processing in accordance with orthogonal frequency-division multiple access (OFDMA) and processing in accordance with target wake time (TWT).

14. The electronic apparatus according to claim 1,
wherein the electronic apparatus is capable of changing the connection destination to an access point that uses a 6 GHz band by changing the connection destination based on the change request.

15. The electronic apparatus according to claim 1, further comprising:
a printer that prints an image onto a print media.

16. A method for controlling an electronic apparatus, comprising:
receiving a change request of an access point serving as a connection destination from a connected access point;
setting a setting value relating to security of the electronic apparatus; and
controlling whether or not to suppress change of an access point serving as the connection destination based on the change request, based on the set setting value.

17. A non-transitory computer-readable storage medium storing a program configured to cause a computer of an electronic apparatus to:
receive a change request of an access point serving as a connection destination from a connected access point;
set a setting value relating to security of the electronic apparatus; and
control whether or not to suppress change of an access point serving as the connection destination based on the change request, based on the set setting value.
